(19) United States
(12) Patent Application Publication
(10) Pub. No.: US 2025/0356182 A1
(43) Pub. Date: Nov. 20, 2025

(54) METHOD AND SYSTEM FOR ONLINE TRAINING OF INTELLIGENT OPTICAL COMPUTING

(71) Applicant: TSINGHUA UNIVERSITY, Beijing (CN)

(72) Inventors: Lu FANG, Beijing (CN); Zhiwei XUE, Beijing (CN); Tiankuang ZHOU, Beijing (CN)

(21) Appl. No.: 19/016,389

(22) Filed: Jan. 10, 2025

(30) Foreign Application Priority Data
May 20, 2024 (CN) 202410623534.3

(51) Int. Cl. G06N 3/067

(52) U.S. Cl. CPC G06N 3/067

(57) ABSTRACT

A method for online training of intelligent optical computing, applied to a free space system, includes: generating coherent light of a preset wavelength, and expanding coherent light wavefront using a beam expander, and splitting the coherent light wavefront into a first and second path light beams; inputting the first path light beam into a first spatial light modulator for data/error complex field loading and taking the second path light beam as an interfering light beam, the first spatial light modulator operating in an amplitude modulation mode; relaying the amplitude-modulated light field to a second spatial light modulator through a 4F system for phase modulation, and obtaining an output light beam by passing the second path light beam through a half-wave plate and linear polarizer after polarization adjustment using the half-wave plate; and determining an amplitude and a phase of a beam measurement result by measuring the output light beam.

### CROSS-REFERENCE TO RELATED APPLICATIONS

This application claims priority to Chinese Patent Application No. 202410623534.3, filed May 20, 2024, the entire disclosure of which is hereby incorporated herein by reference.

### TECHNICAL FIELD

The present disclosure relates to the field of intelligent optical computing technologies, and particularly to a method and a system for online training of intelligent optical computing.

### BACKGROUND

In an era of unprecedented advances in information technologies, the quest for faster and more efficient computation methods has become a driving force of innovation. Among them, optical computing is a nontraditional computing paradigm, which utilizes the unique properties of light to perform computational tasks with advantages of ultra-high processing speeds, massive parallelism, and low power consumption. The attractiveness of the optical computing lies in utilizing inherent properties of light, such as speed, parallelism and coherence. Unlike a traditional electronic computer which relies on movement of electrons through semiconductor materials, the optical computing utilizes photons (particles of light) for computation. This paradigm shift opens up a new possibility for solving complex computational problems and promises to revolutionize fields ranging from communications and image processing to artificial intelligence and pattern recognition.

Additionally, more efficient and scalable training methods have been a pressing issue in the field of artificial intelligence and machine learning. The traditional electronic computing method suffers from slow speed, high energy consumption, and poor scalability, thus new alternative computing paradigms have begun to emerge, the most notable of which is the optical training. The optical training represents an emerging paradigm in machine learning which utilizes the unique properties of light to accelerate and enhance the training process. In contrast to traditional electronic computing, optical training utilizes photons (particles of light) to perform computational tasks. The method offers the advantages of ultra-high processing speed, tremendous parallelism, and low energy consumption, and thus has great potential for solving the increasingly complex challenges in modern artificial intelligence and machine learning.

### SUMMARY

According to a first aspect of the present disclosure, there is provided a method for online training of intelligent optical computing. The method is applied to a free space system, and includes:
generating coherent light of a preset wavelength by using a solid state laser, and expanding coherent light wavefront by using a beam expander, and splitting the coherent light wavefront into a first path light beam and a second path light beam by using a beam splitter;
inputting the first path light beam into a first spatial light modulator for data/error complex field loading and taking the second path light beam as an interfering light beam, wherein the first spatial light modulator for field loading is configured to operate in an amplitude modulation mode;
relaying the amplitude-modulated light field to a second spatial light modulator through a 4F system for phase modulation, and obtaining an output light beam by passing the second path light beam through a half-wave plate and linear polarizer after polarization adjustment using the half-wave plate;
determining an amplitude and a phase of a beam measurement result by measuring the output light beam using a detecting symmetric propagation system.

According to a second aspect of the present disclosure, there is provided a method for online training of intelligent optical computing. The method is applied to an integrated photonic chip system, and includes:
generating a dual-channel input laser signal by using a laser source;
controlling light polarization in an optical fiber by using a polarization controller, and shaping and adjusting the input laser signal by using a variable optical attenuator after the polarization control;
coupling the adjusted input laser signal to a photonic chip through an input optical fiber array, attenuating the dual-channel input laser signal through a variable optical attenuator on the photonic chip, and splitting the input laser signal into two independent output paths to obtain an output light; and
generating photocurrent by passing the output light through an output optical fiber array, converting the photocurrent into a voltage signal after being amplified by a transimpedance amplifier, and obtaining an analysis result by detecting and analyzing the voltage signal using an oscilloscope.

According to a third aspect of the present disclosure, there is provided a system for online training of intelligent optical computing. The system includes: a processor; and a memory storing instructions executable by the processor. The processor is configured to:
generate coherent light of a preset wavelength by using a solid state laser, and expand coherent light wavefront by using a beam expander, and split the coherent light wavefront into a first path light beam and a second path light beam by using a beam splitter;
input the first path light beam into a first spatial light modulator for data/error complex field loading and take the second path light beam as an interfering light beam, wherein the first spatial light modulator for field loading is configured to operate in an amplitude modulation mode;
relay the amplitude-modulated light field to a second spatial light modulator through a 4F system for phase modulation, and obtain an output light beam by passing the second path light beam through a half-wave plate and linear polarizer after polarization adjustment using the half-wave plate; and
determine an amplitude and a phase of a beam measurement result by measuring the output light beam using a detecting symmetric propagation system.

According to a fourth aspect of the present disclosure, there is provided a system for online training of intelligent optical computing. The system includes: a processor; and a memory storing instructions executable by the processor. The processor is configured to perform the method described in the first aspect above.

Additional aspects and advantages of the embodiments of the disclosure will be given in part in the following descriptions, and become apparent in part from the following descriptions, or be learned from the practice of the embodiments of the disclosure.

### BRIEF DESCRIPTION OF THE DRAWINGS

The above-mentioned and/or additional aspects and advantages of the present disclosure will become apparent and readily appreciated from the following description of the embodiments in conjunction with the accompanying drawings.

FIG. 1 is a flow chart of a method for online training of intelligent optical computing according to an embodiment of the present disclosure.

FIG. 2 is an architectural diagram of a free space system according to an embodiment of the present disclosure.

FIG. 3 is a flow chart of a method for online training of intelligent optical computing according to an embodiment of the present disclosure.

FIG. 4 is an architectural diagram of an integrated photonic chip system according to an embodiment of the present disclosure.

FIG. 5 is a structural schematic diagram of a system for online training of intelligent optical computing according to an embodiment of the present disclosure.

FIG. 6 is a structural schematic diagram of a system for online training of intelligent optical computing according to an embodiment of the present disclosure.

### DETAILED DESCRIPTION

It is noted that embodiments and features of the embodiments of the present disclosure may be combined with each other without conflict. The present disclosure will be explained in detail below in connection with the embodiments with reference to the accompanying drawings.

In order to enable those skilled in the art to better understand the aspects of the present disclosure, the embodiments of the present disclosure will now be clearly and fully described in combination with the accompanying drawings of the embodiments of the present disclosure. It is apparent that the described embodiments are merely a part of, but not all of, the embodiments of the present disclosure. Based on the embodiments in the present disclosure, all other embodiments obtained by a person of ordinary skill in the art without inventive step shall fall within the scope of protection of the present disclosure.

A method and system for online training of intelligent optical computing according to the embodiments of the present disclosure are described below with reference to the drawings.

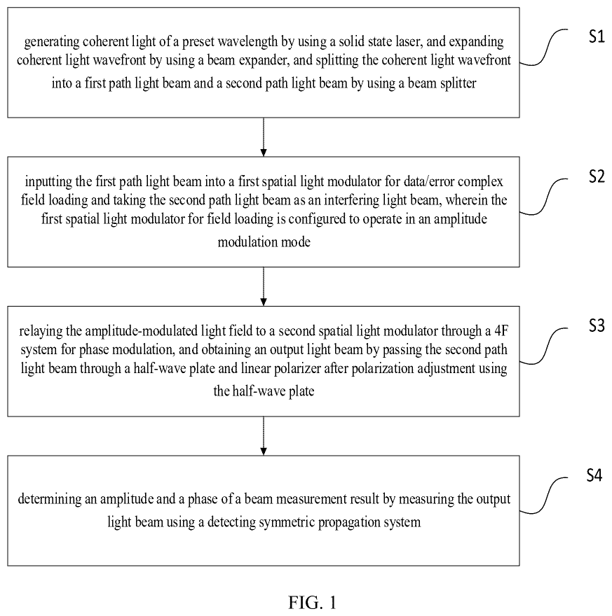

Referring to FIG. 1, which is a flow chart of a method for online training of intelligent optical computing according to an embodiment of the present disclosure.

As shown in FIG. 1, the method is applied to a free space system, and includes:
S1, generating coherent light of a preset wavelength by using a solid state laser, and expanding coherent light wavefront by using a beam expander, and splitting the coherent light wavefront into a first path light beam and a second path light beam by using a beam splitter;
S2, inputting the first path light beam into a first spatial light modulator for data/error complex field loading and taking the second path light beam as an interfering light beam, wherein the first spatial light modulator for field loading is configured to operate in an amplitude modulation mode;
S3, relaying the amplitude-modulated light field to a second spatial light modulator through a 4F system for phase modulation, and obtaining an output light beam by passing the second path light beam through a half-wave plate and linear polarizer after polarization adjustment using the half-wave plate; and
S4, determining an amplitude and a phase of a beam measurement result by measuring the output light beam using a detecting symmetric propagation system.

It may be understood that the embodiments of the present disclosure realize efficient and highly accurate training of the optical system of the large-scale intelligent optical computing system. A prerequisite for realizing the optical training is dividing the system into a modulation region and a propagation region. In the modulation region, the refractive index may achieve various functions through electro-optical or plenoptical reconstruction, while in the propagation region, the refractive index remains fixed. This division provides the basic framework for the optical training, allowing parameters of the optical system to be flexibly tuned and optimized. Full-forward-mode gradient descent learning is one of the key methods for optical training. Unlike a traditional backpropagation-based method, the fully-forward-mode gradient descent learning does not require backpropagation of the light field; rather, the gradient with respect to the refractive index is computed by feeding the error field into the system and measuring the light field at the output. The advantage of this method is that the complex backpropagation process is avoided, and the efficiency and stability of the training is improved.

It should be understood that basic elements of the free space optical system of the embodiments of the present disclosure are the refractive index, the gain and the loss, which may be summarized as the real and imaginary parts of the refractive index: n=n_{R}+inₗ. Herein, the present disclosure will prove two conclusions. First, linear propagation of the optical system can be reformulated as a linearly connected neural network. Second, the neural network is differentiable, and the system parameters can be designed by gradient descent.

Considering the optical system controlled by a Maxwell's equation, (∇×∇×−μ₀ϵ₀ω₀²ϵᵣ)E=−jμ₀μᵣω₀J, where E is an electric field distribution, J is a current source, and ϵ₀, ϵᵣ, μ₀, μᵣ, are vacuum, relative permittivity, and magnetic permeability, respectively. The Maxwell's equation can be vectorized as A(ϵᵣ) E=μᵣJ. Since the considered cases are formed with the same current source J, the same input electric field Et, and the same output electric field Eₒ, which satisfy AᵢEᵢ=μᵣJ and AₒEₒ=μᵣJ. The present disclosure then proceeds to prove that in the linear system, there exists a pseudo-inverse matrix Aₒ⁺ which makes Aₒ⁺Aₒ=I, where I is a unit matrix.

Prove: let J∈C^{N}^{ⱼ}, Eₒ∈C^{N}^{ₒ}, and jᵢ be an i-th one-hot vector with nonzero position, then jᵢ will be the base current source J=Σᵢαᵢjᵢ. For each jᵢ as a source of the system, denoting the output electric field distribution as eᵢ(eᵢ∈C^{N}^{ₒ}), which is Aₒeᵢ=jᵢ. Since the in system is linear, outputting Eₒ=Σᵢαᵢeᵢ=[e₁, e₂, . . . , e_{N}_{ⱼ}] [α₁, α₂, . . . , α_{N}_{ⱼ}]^{T}, which shows Eₒ=[e₁, e₂, . . . , e_{N}_{ⱼ}]J. Comparing this with a control forward Maxwell's equation AₒEₒ=J, the present disclosure concludes that Aₒ⁺=[e₁, e₂, . . . , e_{N}_{ⱼ}] satisfying Aₒ⁺Aₒ=I.

Substituting Aₒ⁺Aₒ=I into a set of Maxwell's equations for the input and output fields, the input field Eᵢ and the output field Eₒ can be connected by the following equation:

$${E}_{o} = {A}_{o}^{+} {A}_{i} {E}_{i}$$

In this case Aₒ⁺ and Aᵢ are parameterized as ϵᵣ. It can be noted from the above that, the linear propagation of the light field depicts a linear layer connecting the input and output with a fully connected weight matrix W(ϵᵣ)=Aₒ⁺Aᵢ. The present disclosure further considers the gradient descent design of the parameters and the relaying between the layers. It is first noted that the wavefield is manipulated in two forms: modulation and coherent interference, where the modulation can be represented as point-by-point multiplication and the coherent interference can be represented as addition in a complex field. Considering the modulation process: Eᵢ=Eᵢ′exp (\sqrt{jϵᵣ}(Δd)/2)=Eᵢ′exp (j (n_{R}+inₗ)(Δd)/λ) where Δd is a modulation distance, λ is a wavelength, and n_{R}, nₗ are the real and imaginary parts of the refractive index. When combining the coherent reference beams, E′ᵢ=(Eᵢ_{ₒ}+Eᵢ_{_{ref}}). Therefore, the input field extends to Eᵢ=(Eᵢ_{ₒ}+Eᵢ_{_{ref}}) exp (2πj(n_{R}+in_{I})(Δd)/λ). The end-to-end embedded neural network is represented as

$$y = f ( x ; {n}_{R} , {n}_{I} , B ) = W ( {n}_{R}^{( 0 )} , {n}_{I}^{( 0 )} ) ( M ( {n}_{R}^{( t )} , {n}_{I}^{( t )} ) \cdot ( x + B ) )$$

where

$$x = {E}_{{i}_{o}} , y = {E}_{o} , M = exp ( 2 π j ( {n}_{R}^{( t )} + i {n}_{I}^{( t )} ) ( Δ d ) / λ ) , B = {E}_{{i}_{ref}}$$

are mapped to the input, the output, the complex multiplication, and the bias weight in the neural network implementation, and

$$( {n}_{R}^{( 0 )} , {n}_{I}^{( 0 )} ) and ( {n}_{R}^{( t )} , {n}_{I}^{( t )} )$$

denote the refractive indexes of the fix and modulation regions, respectively. For simplicity, the present disclosure omits the reference input in the description. In practice, the system is designed for target T and associated quantitative loss function is denoted as L. The gradient with respect to a complex refractive index

$$n = {n}_{R}^{( t )} + i {n}_{I}^{( t )}$$

is

$$\frac{\partial L}{\partial n} = - \frac{2 Δ d}{λ} conj ( j ( M \cdot ( x + B ) \cdot ( {W}^{T} \frac{\partial L}{\partial y} ) )$$

The gradients of the input system and the reference system are

$$\frac{\partial L}{\partial x} = \frac{\partial L}{\partial B} = M \cdot ( {W}^{T} \frac{\partial L}{\partial y} )$$

In this way, the gradients of all parameters in the system may be retrieved and designed through gradient descent.

For a multilayer parametric optical system, the present disclosure will describe a gradient descent algorithm for the system. Re-expressing a propagation matrix W of a k-th linear optical layer in the above expression as a Green's function Gₖ(rₒ, rᵢ), the forward propagation may be expressed as follows:

$${y}_{k} ( {r}_{o} ) = \int {G}_{k} ( {r}_{o} , {r}_{i} ) {x}_{k} ( {r}_{i} ) d ( {r}_{i} )$$

The output may be non-linearly activated and fed into a subsequent layer xₖ₊₁=f(yₖ). A quality factor is evaluated based on the final output, L=Ψ(y_{N}, T), where T is the target output. To efficiently evaluate the loss, the gradient is computed using the loss function L. The gradient y_{N} is:

$$δ {y}_{N} = \frac{\partial L}{\partial {y}_{N}} = {Ψ}_{x}^{′} ( {y}_{N} , T )$$

According to the chain rule, the gradient propagates is:

$${δ}_{{x}_{k}} ( {r}_{i} ) = \int {δ}_{{y}_{k}} ( {r}_{o} ) \frac{\partial {y}_{k} ( {r}_{0} )}{\partial {x}_{k} ( {r}_{i} )} d ( {r}_{o} ) = \int {G}_{k} ( {r}_{o} , {r}_{i} ) {δ}_{y} ( {r}_{o} ) d ( {r}_{o} )$$

According to the Lorentz reciprocity, Gₖ(rₒ, rᵢ)=Gₖ(rᵢ, rₒ), which makes,

$${δ}_{{x}_{k}} ( {r}_{i} ) = \int {G}_{k} ( {r}_{i} , {r}_{o} ) {δ}_{y} ( {r}_{o} ) d ( {r}_{o} )$$

This corresponds to the propagation of field δ_{y} from the output of layer k to the input of layer k.

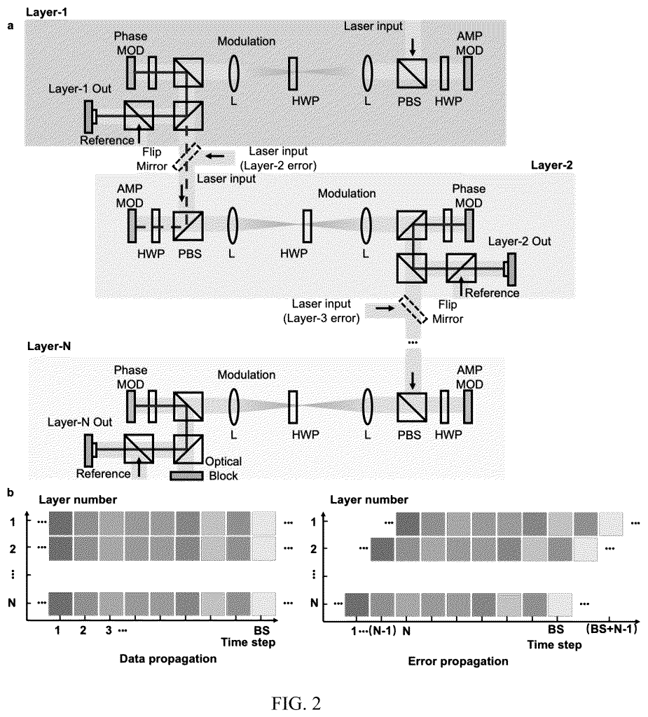

As shown in FIG. 2, the method for online training is applied to the free space system for experiments according to an embodiment of the present disclosure.

Specifically, in the free space system, a source for the optical calculation is generated using a solid-state laser (MFL-FN-532) operating at 532 nm. Coherent optical wavefront is expanded using a beam expander and then is split into two paths by a beam splitter (BS013, Thorlabs). One path points to a spatial light modulator (SLM) for data/error complex field loading, while the other path is used as an interfering light beam whose light intensity is attenuated by two polarizers (LPNIR100-MP2, Thorlabs). The SLM (X15213-01, HAMAMATSU) for field loading is configured to operate in amplitude modulation mode, which consists of 1280×1024 modulation elements with a pitch of 12.5 μm, and a programmed depth of 8 bits. The spatial light modulator may modulate an incident light at up to 60 Hz. The amplitude-modulated light field is then relayed 1:1 to another SLM (E-series, meadowlark) through a 4F system for phase modulation. After polarization adjustment with a half-wave sheet, passing the second path light beam through the half-wave sheet and a linear polarizer. The phase modulation SLM is a reflective silicon-based liquid crystal component with up to 91% zero-level diffraction efficiency, contains 1920×1200 modulation cells, each with a size of 8 μm and 8-bit precision. The phase modulation SLM has a maximum frame rate of 60 Hz and an update time of 17 ms, which is suitable for both electric field loading and design phase loading. The wavefront carries the input light field and design phase, and then a detecting symmetric propagation system is used to perform a specific task. The output light beam is measured by two separate sensors before propagating a length of 0.388 m. A CMOS sensor (BFS-U3-89S6M, Flir) is used to measure the complex field with good quantum efficiency (63.99%) and low dark noise (2.47e−). Two sensors are used to measure the amplitude and phase of the results separately. The CMOS sensor achieves a maximum frame rate of 42 Hz with a pixel setting of 4096×2160, where each pixel size is 3.45 μm and the readout value is configured to 8 bits. For the free space system, each propagation takes the same time regardless of the complexity of the system. The commercial spatial light modulator can be faster than 1 kHz (HSP1K-488-800-PC8, Meadowlark Optics), so the propagation time is less than 2.0 ms per iteration.

The method for online training of intelligent optical computing of the embodiments of the present disclosure avoids the complex backpropagation process and improves the efficiency and stability of the training. The optical training is executed on a specific physical system to accomplish the training process of the optical network in an efficient way. The system is capable of training the deep photonic neural network with millions of parameters online, as well as handling the optical imaging system in complex scenes. The online training method dramatically increases the training speed and achieves highly accurate training results under resource-constrained conditions.

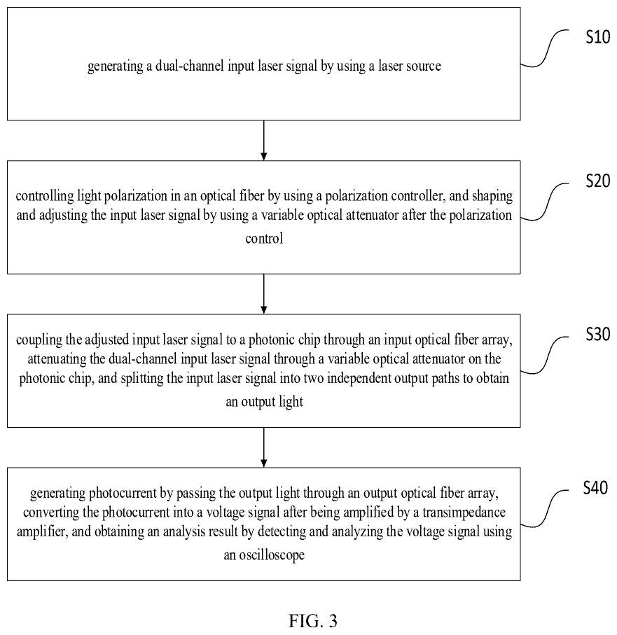

FIG. 3 is a method for online training of intelligent optical computing. The method is applied to an integrated photonic chip system, and includes:
S10, generating a dual-channel input laser signal by using a laser source;
S20, controlling light polarization in an optical fiber by using a polarization controller, and shaping and adjusting the input laser signal by using a variable optical attenuator after the polarization control;
S30, coupling the adjusted input laser signal to a photonic chip through an input optical fiber array, attenuating the dual-channel input laser signal through a variable optical attenuator on the photonic chip, and splitting the input laser signal into two independent output paths to obtain an output light; and
S40, generating photocurrent by passing the output light through an output optical fiber array, converting the photocurrent into a voltage signal after being amplified by a transimpedance amplifier, and obtaining an analysis result by detecting and analyzing the voltage signal using an oscilloscope.

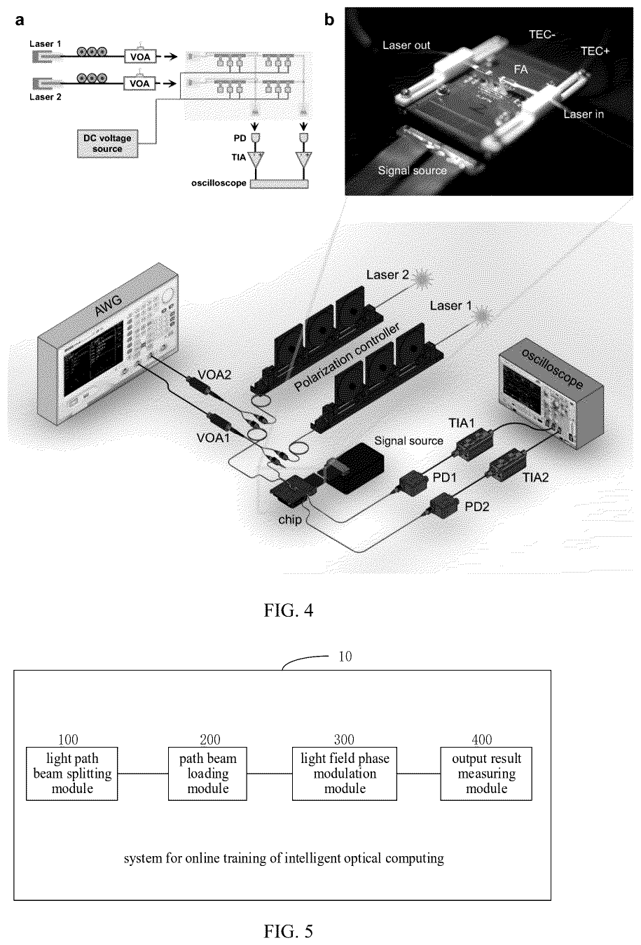

Specifically, FIG. 4 shows an integrated photonic chip system according to an embodiment of the present disclosure, in which the chip is produced in a silicon photonic foundry. The chip integrates various components, such as a passive grating coupler, a waveguide, and a multimode interferometer, which are fabricated on a silicon on insulator (SOI) platform using a standard etching process.

Specifically, two laser sources with 10 mW of power are used in the system to generate a dual-channel input. One laser operates at a precise wavelength of 1550 nm, while the other laser operates at a precise wavelength of 1551 nm. A polarization controller is used to control the polarization of light within the fiber to ensure that the desired polarization is achieved. After polarization control, a variable optical attenuator (V1550A, Thorlabs) is used to shape and adjust the input signal. The output of the variable optical attenuator is then optically coupled to the photonic chip through an input fiber array. On the chip, four variable optical attenuators (VOAs) attenuate the dual-channel input light, and the dual-channel input light is split into two separate output paths. The attenuated light is then detected by a photodiode (DET01CFC, Thorlabs) on the chip. The output light passes through the output optical fiber array, and the generated photocurrent is amplified by a transimpedance amplifier (TIA, AMP100, Thorlabs) and is converted into the voltage signal, and finally the dual-channel output is detected and analyzed by an oscilloscope. Additionally, an eight-channel fiber array with an angle of 8° is used to guide the light in and out of the photonic chip. After aligning the fiber arrays with the grating array under a microscope with the help of a nano electric translation stage, the vertically coupled fiber arrays are connected and fixed to the PIC using a curable epoxy resin. A measured insertion loss of the fiber-to-chip coupling after encapsulation is approximately-8 dB per channel. A two-layer dedicated PCB is used for on-chip electrical signal feed. A pad on a sheet of a VOA array with a period of 100 μm is bonded and connected to the PCB board through a gold wire, and the sheet of the VOA array is independently routed to an electrical socket through a signal line with a period of 800 μm. A customized multi-channel DC signal source is connected to the board, and the injection current of the VOA is controlled by setting a voltage 0-5V, the imaginary part of the effective refraction of the guided mode wave is effectively regulated. To achieve thermal stability, a photonic chip core and a thermistor is mounted on a copper block using a thermal adhesive, a temperature of the chip is measured using the thermistor, a thermoelectric temperature controller (TEC) is connected to the copper block to cool the package system, and a proportional-integrated-derivative (PID) feedback loop is established between the thermistor and the thermoelectric temperature controller. This feedback loop maintains the on-chip temperature within ±0.004 Kelvin (equivalent to ±2Ω thermistor long-term stability), ensuring reliable and consistent operation.

It is known that most of the training operations in different optical systems are implemented experimentally online. The present disclosure explains how the remaining operations may be performed in the field. Both loss calculations and gradient calculations may be implemented by on-site optical or electronic devices. The loss calculation involves a minus operation, which can be realized by a π phase shift (equivalent to a −1 value in the complex representation of light), and for an interference calculation, a difference between the output y and the target T is calculated, e=y−T.

The gradient of the parameter g∝(Re{1jE_{data}Eₑᵣᵣₒᵣ}-Im{1jE_{data}Eₑᵣᵣₒᵣ}). Thus the gradient calculation involves computing the real and imaginary parts of the field E_{data}Eₑᵣᵣₒᵣ. In order to calculate Re{1jE_{data}Eₑᵣᵣₒᵣ}, intensities of the three fields require to be detected: A=|E_{data}⁺1jEerror|², B=| E_{data}|², and C=|Eₑᵣᵣₒᵣ|², and the sum of the gradient is Re{1jE_{data}Eₑᵣᵣₒᵣ}=(A-B-C)/2, where the phase conjugation may be realized through a phase conjugate mirror, and the difference operation may be realized by balanced photoelectric detection. Similarly, the intensity A′=|E_{data}⁺Eₑᵣᵣₒᵣ|² may be measured. Then the present disclosure has Im{1jE_{data}Eₑᵣᵣₒᵣ}=(A′−B−C)/2. The detected gradient signal will be further accumulated by an integration circuit to determine the modulator and tune the refractive index. The gradient may also be used to directly update the refractive index of the non-volatile optical material.

According to the method for online training of intelligent optical computing of the present disclosure, compared to physical artificial intelligence methods designed offline that are inevitably imperfect due to the prevailing noise and general uncertainty in the nature of physics, the online machine learning method proposed in the present disclosure alleviates the limitations of numerical modeling and achieves high-performance general optical artificial intelligence and optical artificial intelligence, and experimentally demonstrates the method for online training of an integrated photonic chip system, which performs the optical training on the specific physical system and completes the training process of the optical network in an efficient way.

To implement the above embodiments, as shown in FIG. 5, an embodiment of the present disclosure also provides a system 10 for online training of intelligent optical computing. The system includes:
a light path beam splitting module 100, configured to generate coherent light of a preset wavelength by using a solid state laser, and expand coherent light wavefront by using a beam expander, and split the coherent light wavefront into a first path light beam and a second path light beam by using a beam splitter;
a path beam loading module 200, configured to input the first path light beam into a first spatial light modulator for data/error complex field loading and take the second path light beam as an interfering light beam, wherein the first spatial light modulator for field loading is configured to operate in an amplitude modulation mode;
a light field phase modulation module 300, configured to relay the amplitude-modulated light field to a second spatial light modulator through a 4F system for phase modulation, and obtain an output light beam by passing the second path light beam through a half-wave plate and linear polarizer after polarization adjustment using the half-wave plate;
an output result measuring module 400, configured to determine an amplitude and a phase of a beam measurement result by measuring the output light beam using a detecting symmetric propagation system.

According to the system for online training of intelligent optical computing of the embodiments of the present disclosure, the complex backpropagation process can be avoided, and the efficiency and stability of the training can be improved. The optical training is executed on the specific physical system to accomplish the training process of the optical network in an efficient way. The system is capable of training deep photonic neural networks with millions of parameters online, as well as handling optical imaging systems in complex scenes. The online training approach dramatically increases the training speed and achieves highly accurate training results under resource-constrained conditions.

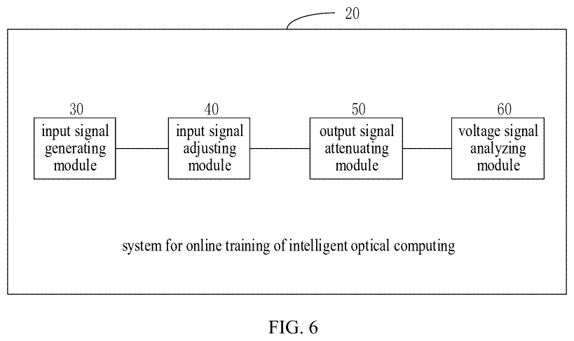

To implement the above embodiment, as shown in FIG. 6, an embodiment of the present disclosure also provides a system 20 for online training of intelligent optical computing. The system 20 includes:
an input signal generating module 30, configured to generate a dual-channel input laser signal by using a laser source;
an input signal adjusting module 40, configured to control light polarization in an optical fiber by using a polarization controller, and shape and adjust the input laser signal by using a variable optical attenuator after the polarization control;
an output signal attenuating module 50, configured to couple the adjusted input laser signal to a photonic chip through an input optical fiber array, attenuate the dual-channel input laser signal through a variable optical attenuator on the photonic chip, and split the input laser signal into two independent output paths to obtain an output light; and
a voltage signal analyzing module 60, configured to generate photocurrent by passing the output light through an output optical fiber array, converting the photocurrent into a voltage signal after being amplified by a transimpedance amplifier, and obtain an analysis result by detecting and analyzing the voltage signal using an oscilloscope.

According to the system for online training of intelligent optical computing of the present disclosure, compared to physical artificial intelligence methods designed offline that are inevitably imperfect due to the prevailing noise and general uncertainty in the nature of physics, the online machine learning method proposed in the present disclosure alleviates the limitations of numerical modeling and achieves high-performance general optical artificial intelligence and optical artificial intelligence, and experimentally demonstrates the online training method for the integrated photonic chip system, which performs the optical training on the specific physical system and completes the training process of the optical network in an efficient way.

In the description of the specification, reference to the terms “an embodiment,” “some embodiments,” “an example,” “a particular example,” or “some examples” or the like means that a particular feature, structure, material, or characteristic described in connection with the embodiment or example is included in at least one embodiment or example of the present disclosure. In the specification, illustrative expressions of such terms are not necessarily directed to the same embodiment or example. Furthermore, the particular feature, structure, material, or characteristic described may be combined in any suitable manner in any one or more embodiments or examples. Furthermore, the different embodiments or examples and the features of the different embodiments or examples described in the specification may be combined by those skilled in the art without contradiction.

Furthermore, the terms “first” and “second” are used for descriptive purposes only and are not to be understood as indicating or implying relative importance or as implying a number of indicated technical features. Thus, a feature defined with “first” and “second” may explicitly or implicitly include at least one such feature. In the description of the present disclosure, “a plurality of” means at least two, e.g., two, three, etc., unless explicitly specifically defined otherwise.

What is claimed is:

1. A method for online training of intelligent optical computing, applied to a free space system, comprising:
generating coherent light of a preset wavelength by using a solid state laser, and expanding coherent light wavefront by using a beam expander, and splitting the coherent light wavefront into a first path light beam and a second path light beam by using a beam splitter;
inputting the first path light beam into a first spatial light modulator for data/error complex field loading and taking the second path light beam as an interfering light beam, wherein the first spatial light modulator for field loading is configured to operate in an amplitude modulation mode;
relaying the amplitude-modulated light field to a second spatial light modulator through a 4F system for phase modulation, and obtaining an output light beam by passing the second path light beam through a half-wave plate and linear polarizer after polarization adjustment using the half-wave plate; and
determining an amplitude and a phase of a beam measurement result by measuring the output light beam using a detecting symmetric propagation system.

2. The method according to claim 1, wherein the amplitude modulation mode is formed by 1280×1024 modulation elements with a pitch of 12.5 μm, and a programming depth of 8 bits.

3. The method according to claim 1, wherein the second spatial light modulator comprises 1920×1200 modulation elements, each modulation element having a size of 8 μm and an 8-bit precision, a maximum frame rate of the second spatial light modulator is 60 Hz, and an update time of the second spatial light modulator is 17 ms.

4. The method according to claim 1, wherein the detecting symmetric propagation system comprises at least a complementary metal oxide semiconductor (CMOS) sensor, the CMOS sensor is configured to achieve a maximum frame rate of 42 Hz, with a corresponding pixel set as 4096×2160, where each pixel has a size of 3.45 μm and a readout value configured as 8-bit.

5. A method for online training of intelligent optical computing, applied to an integrated photonics circuit system, comprising:
generating a dual-channel input laser signal by using a laser source;
controlling light polarization in an optical fiber by using a polarization controller, and shaping and adjusting the input laser signal by using a variable optical attenuator after the polarization control;
coupling the adjusted input laser signal to a photonic chip through an input optical fiber array, attenuating the dual-channel input laser signal through a variable optical attenuator on the photonic chip, and splitting the input laser signal into two independent output paths to obtain an output light; and
generating photocurrent by passing the output light through an output optical fiber array, converting the photocurrent into a voltage signal after being amplified by a transimpedance amplifier, and obtaining an analysis result by detecting and analyzing the voltage signal using an oscilloscope.

6. The method according to claim 5, further comprising:
aligning the input optical fiber array and the output optical fiber array respectively with a grating array, connecting and fixing the vertically coupled optical fiber arrays to an integrated circuit of a printed circuit board (PCB) using a curable epoxy resin; and
performing electrical signal feeding on the photonic chip through a two-layer PCB, bonding and connecting a pad on a sheet of a variable optical attenuator array with a period of 100 μm to the PCB through a gold wire, and independently routing the sheet of the variable optical attenuator array to an electrical socket through a signal line with a period of 800 μm.

7. The method according to claim 6, further comprising:
connecting a multi-channel direct current signal source to the PCB and controlling injection current of the variable optical attenuator by setting a voltage 0-5V, adjusting an imaginary portion of effective refraction of a guided mode wave.

8. The method according to claim 5, further comprising:
mounting a photonic chip core and a thermistor on a copper block by using a thermal adhesive, measuring a temperature of the chip by using the thermistor, connecting a thermoelectric temperature controller to the copper block to cool a packaging system, and establishing a proportional-integral-derivative feedback loop between the thermistor and the thermoelectric temperature controller.

9. A system for online training of intelligent optical computing, comprising:
a processor; and
a memory storing instructions executable by the processor, wherein the processor is configured to:
generate coherent light of a preset wavelength by using a solid state laser, and expand coherent light wavefront by using a beam expander, and split the coherent light wavefront into a first path light beam and a second path light beam by using a beam splitter;
input the first path light beam into a first spatial light modulator for data/error complex field loading and take the second path light beam as an interfering light beam, wherein the first spatial light modulator for field loading is configured to operate in an amplitude modulation mode;
relay the amplitude-modulated light field to a second spatial light modulator through a 4F system for phase modulation, and obtain an output light beam by passing the second path light beam through a half-wave plate and linear polarizer after polarization adjustment using the half-wave plate; and
determine an amplitude and a phase of a beam measurement result by measuring the output light beam using a detecting symmetric propagation system.

10. The system according to claim 9, wherein the amplitude modulation mode is formed by 1280×1024 modulation elements with a pitch of 12.5 μm, and a programming depth of 8 bits.

11. The system according to claim 9, wherein the second spatial light modulator comprises 1920×1200 modulation elements, each modulation element having a size of 8 μm and an 8-bit precision, a maximum frame rate of the second spatial light modulator is 60 Hz, and an update time of the second spatial light modulator is 17 ms.

12. The system according to claim 9, wherein the detecting symmetric propagation system comprises at least a complementary metal oxide semiconductor (CMOS) sensor, the CMOS sensor is configured to achieve a maximum frame rate of 42 Hz, with a corresponding pixel set as 4096×2160, where each pixel has a size of 3.45 μm and a readout value configured as 8-bit.

13. A system for online training of intelligent optical computing, comprising:
a processor; and
a memory storing instructions executable by the processor, wherein the processor is configured to perform the method according to claim 5.
